(19) United States
(12) Patent Application Publication
(10) Pub. No.: US 2013/0233812 A1
(43) Pub. Date: Sep. 12, 2013

(54) FORK LIFT CARRIAGE AND FORK STAND

(71) Applicants: Gustavo Anzola, Lockport, IL (US); William Healy, Wheaton, IL (US)

(72) Inventors: Gustavo Anzola, Lockport, IL (US); William Healy, Wheaton, IL (US)

(21) Appl. No.: 13/414,956

(22) Filed: Mar. 8, 2012

(51) Int. Cl. F16M 13/00

(52) U.S. Cl. 211/49.1

(57) ABSTRACT

A device for storing a fork lift carriage and a plurality of lift forks when each are detached from a fork lift truck. The device having a base frame with a plurality of sides, a leg portion extending downward from an end of each of the plurality of sides forming the base frame, a plurality of elongated fork storage containers attached to the base frame, and a carriage support rack to the base frame opposite of the plurality of fork storage containers.

### FIELD OF THE INVENTION

This invention pertains to equipment used in a material handling operation and, more particularly, to a device for storing a carriage and lift forks used in conjunction with a fork lift truck.

### BACKGROUND OF THE INVENTION

Fork lift trucks are used in various material handling facilities to move goods from one location to another within the facility and on and off of trucks, trains, and vessels that transport such goods. A lift truck allows one individual to move several thousands of pounds of goods at one time resulting in greater efficiency in the handling of materials.

Many of today's lift trucks come with interchangeable lift forks and fork carriages that allow the trucks to lift various pallet sizes and other pieces of equipment. A problem associated with this versatility is the need to be able to store particular lift forks and carriages when they are detached from the truck and not in use. Because the lift forks and carriages are both heavy and cumbersome, they cannot be handled by one person alone. This results in a need for increased manpower to detach and transport a carriage or lift forks from a truck to a storage location. Given the weight of the equipment, their direct handling by individuals can result in personal injuries, some of which could be serious and result in lost productivity and workman compensation issues. Furthermore, given the footprint that the carriage and lift forks generate, it is neither safe nor practical to leave them merely strewn about any given location. For these and other reasons, a device that would allow one to safely stow a fork lift carriage and a plurality of lift forks when they are not attached to a lift truck would be an important improvement in the art.

### BRIEF SUMMARY OF THE INVENTION

A device for storing a fork lift carriage and a plurality of lift forks when each are detached from a fork lift truck is disclosed. The device is comprised of a base frame having a plurality of sides. A leg portion extends downward from an end of each of the plurality of sides forming the base frame. A plurality of elongated fork storage containers are attached to the base frame, and a carriage support rack is attached to the base frame opposite of the plurality of fork storage containers.

### BRIEF DESCRIPTION OF THE DRAWINGS

FIG. 1 is a perspective view showing the fork lift carriage with forks removed and a fork lift carriage and fork stand.

FIG. 2 is a perspective view showing the fork lift carriage and fork stand.

FIG. 3 is a perspective view showing a plurality of lift forks.

FIG. 4 is a front view of a fork lift carriage and fork stand.

FIG. 5 is a side view of a fork lift carriage and fork stand.

FIG. 6 is a top view of a fork lift carriage and fork stand.

FIG. 7a is a side view showing a fork stand.

FIG. 7 b is a side view showing a fork lift carriage.

FIG. 8 is a front view of a fork lift carriage and fork stand showing the carriage attached to the stand.

FIG. 9 is a perspective view showing a fork lift carriage and fork stand with the lift forks stowed in the stand.

FIG. 10 is a perspective view showing a fork lift carriage and fork stand with the carriage and forks stowed together on the stand.

### DETAILED DESCRIPTION OF THE INVENTION

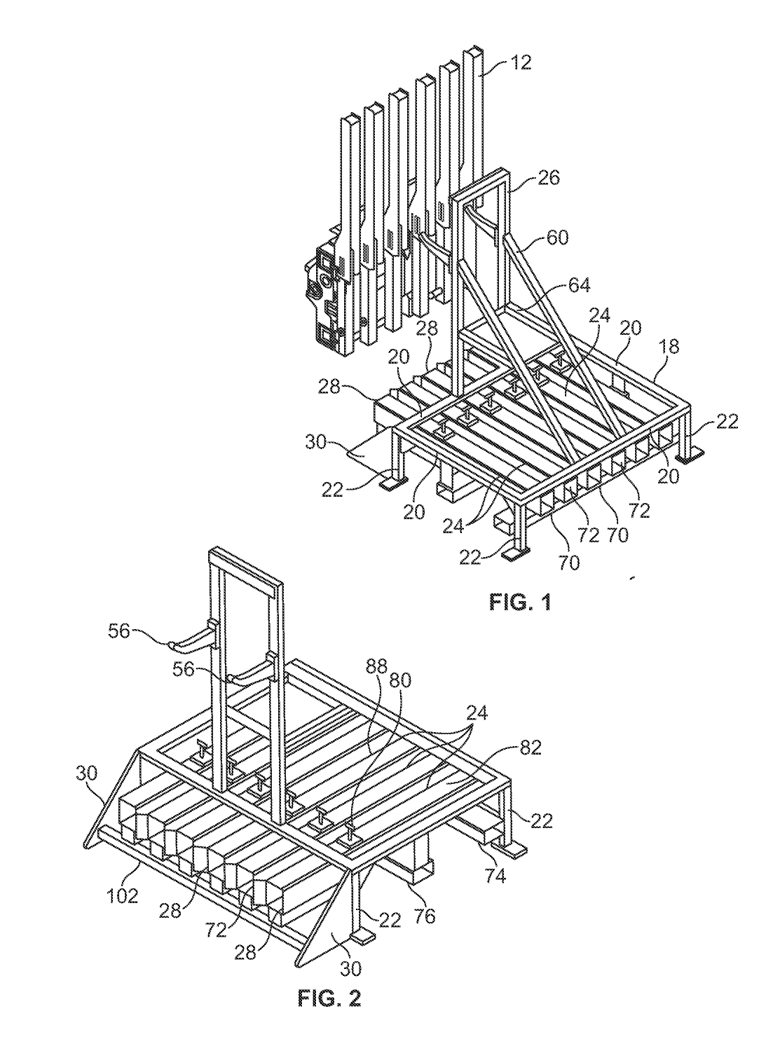

Disclosed is a device 10 for storing a fork lift carriage 12 and a plurality of lift forks 14 when each are detached from a fork lift truck (not shown). As shown in FIGS. 1-2 and 4-8, the device 10 is comprised of a base frame 18 having a plurality of sides 20. A leg portion 22 extends downward from an end of each of the plurality of sides 20 forming the base frame 18. A plurality of elongated fork storage containers 24 are attached to the base frame 18, and a carriage support rack 26 is attached to the base frame 18 opposite of the plurality of fork storage containers 24.

In an embodiment, as shown in FIGS. 1, 2, 5 and 7, a first end 28 of each of the plurality of fork storage containers 24 extends beyond the base frame 18, and a counterbalancing leg portion 30 located proximal to the first end 28 of the fork storage containers 24 extends angularly downward from the sides 20 of the base frame 18 aligned parallel to an elongated axis of said fork storage containers 24.

In an embodiment, the carriage support rack 26 includes a carriage mounting frame 32 extending from the base frame 18, and a carriage support 34 that extends from the carriage mounting frame 32. In a particular version of this embodiment, as shown in FIGS. 1, 2 and 4, the carriage mounting frame 32 is comprised of a first component 36 attached at a first end 38 to the base frame 18, a second component 40 attached at a first end 42 to the base frame 18 and displaced from the first component 36, and a joining component 44 having a first end 46 and a second end 48, whereby the first end 46 of the joining component 44 is attached to a second end 50 of the first component 36, and the second end 48 of the joining component 44 is attached to a second end 52 of the second component 40, thereby forming a frame opening 54.

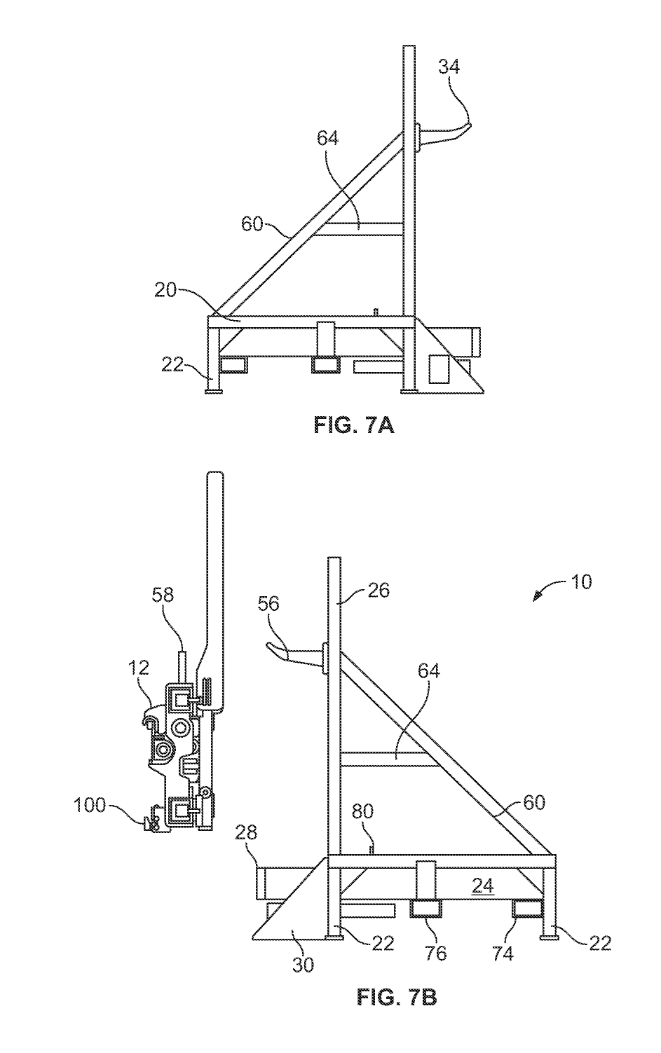

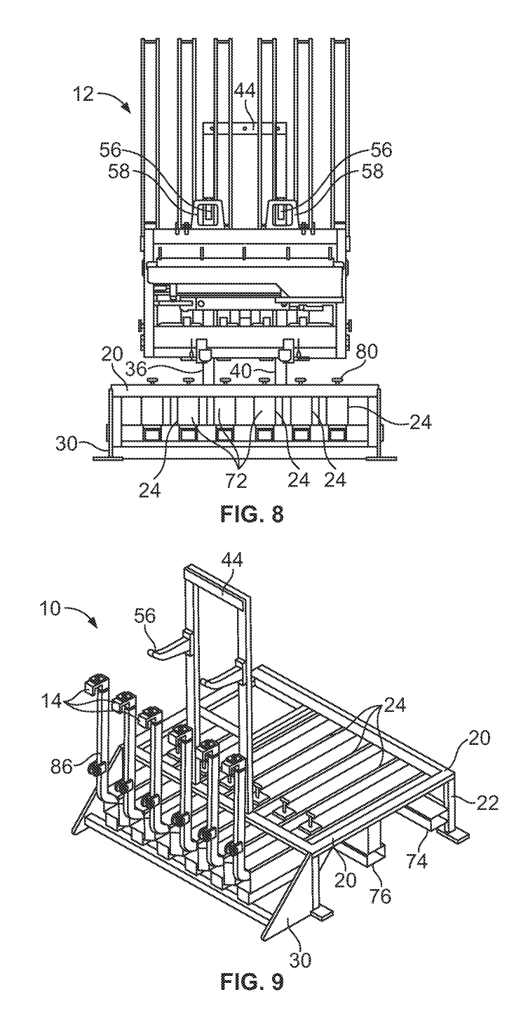

In another version of the embodiment, the carriage support 34 is comprised of a pair of carriage support arms 56 that extend from the carriage mounting frame 32, as shown in FIGS. 1 and 2. In such an embodiment, the fork lift carriage 12 includes mounting rings 58, as shown in FIGS. 7b and 8, and each mounting ring 58 receives one of the pair of carriage support arms 56. In still another embodiment, a carriage-mounting-frame support brace 60 extends from the carriage mounting frame 32 to the base frame 18.

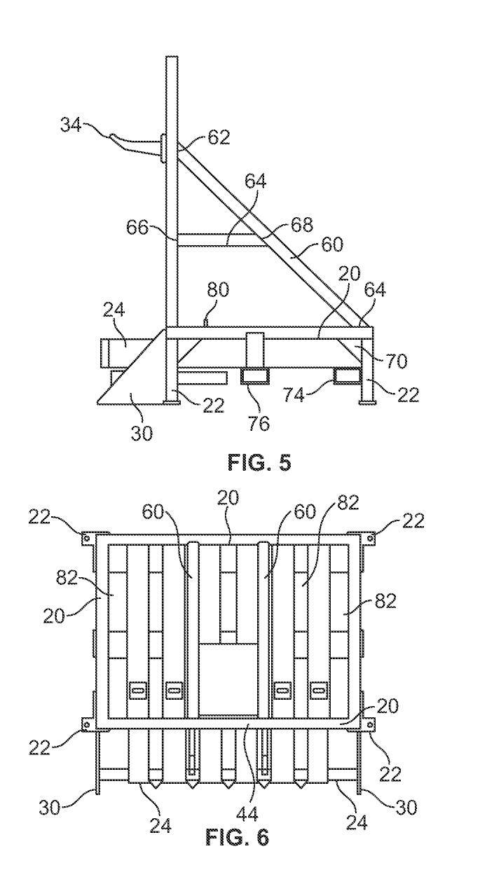

In an embodiment, the carriage-mounting-frame support brace 60 has a first end 62 and a second end 64 opposite the first end 62. The first end 62 of the carriage-mounting-frame support brace 60 is connected to the carriage mounting frame 32, and the second end 64 of the carriage-mounting-frame support brace 60 is attached to the base frame 18, whereby the carriage-mounting-frame support brace 60 forms approximately a 45° angle with both the carriage mounting frame 32 and the base frame 18, as shown in FIGS. 1, 5 and 7a. In a particular version of this embodiment, a support bracket 64 has a first end 66 and a second end 68, the first end 66 of the support bracket 64 is attached to the carriage mounting frame 32 and the support bracket 64 extends perpendicular therefrom, and the second end 68 of the support bracket 64 is attached to the carriage-mounting-frame support brace 60. In one embodiment, the carriage support 34 forms approximately a 90° angle with the carriage mounting frame 32, as shown in FIGS. 5 and 7a.

In another embodiment, each of the plurality of fork storage containers 24 attached to the base frame 18 has a first end 28 and a second end 70. As shown in FIGS. 1 and 2, both the first and second ends 28, 70 define an opening, and a passageway 72 extends through the fork storage container 24 from the first end 28 to the second end 70. In still another embodiment, at least one support beam 74 extends across an underside of the plurality of fork storage containers 24. In a particular version of this embodiment, a first support beam 74 extends across the underside of the plurality of fork storage containers 24 proximal to a second end 70 of the fork storage containers 24, and a second support beam 76 extends across the underside of the plurality of fork storage containers 24 approximately midway between the second end 70 of the fork storage containers 24 and the carriage mounting frame 32. In a more particular version of this embodiment, the support beam 74 defines a passageway that extends through the support beam 74.

In an embodiment, a retaining pin 80 extends from a top side 82 of each of the plurality of fork storage containers 24, as shown in FIGS. 1, 2, 4, 5, 7a and 8. When stowing the fork lift carriage 12 and the lift forks 14 together on the device 10 with the lift forks 14 still attached to the carriage 12, one of the plurality of forks 14 fits between a pair of retaining pins 80. In an embodiment, a retaining pin 80 is located approximately at a midpoint along the length of each of the plurality of fork storage containers 24. In a particular version of this embodiment, the retaining pin 80 is T-shaped, as shown in FIG. 2.

When the lift forks 14 are stored separately from the fork lift carriage 12, one of the plurality of forks 14 is placed into one of the plurality of fork storage containers 24.

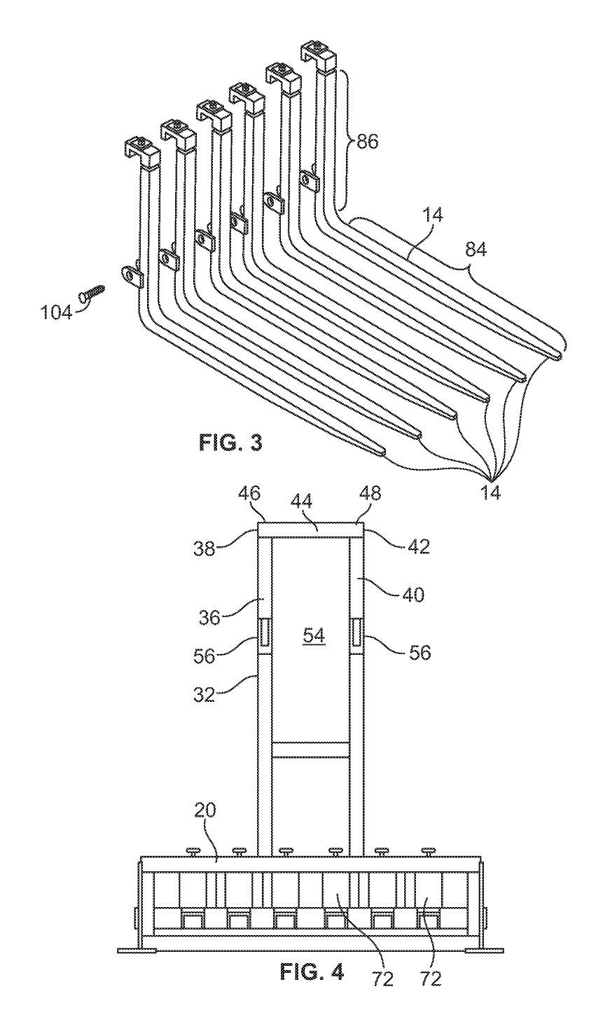

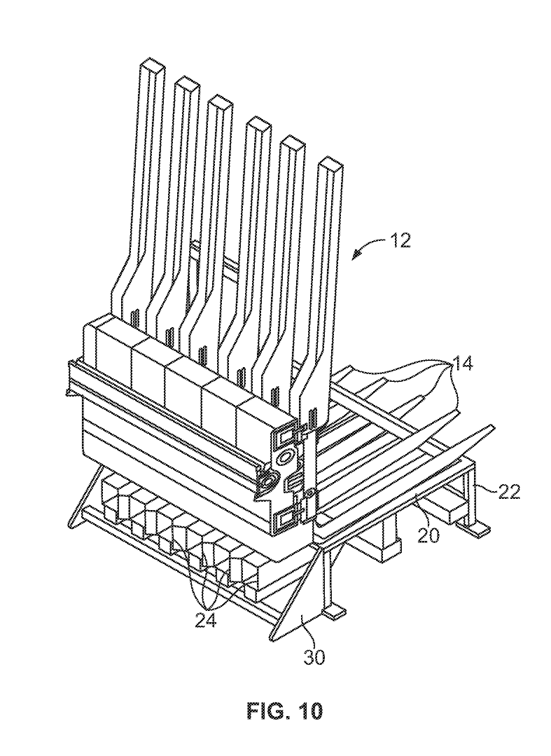

When in operation, the device 10, which may be made of any suitable metallic-like material, is positioned in an area with enough space to allow for the maneuvering of the fork lift carriage 12 and the lift forks 14. If the lift forks 14 are to be stowed individually, an operator inserts the lifting prong 84 of a fork 14 into the opening of a fork storage container 24 proximal to the carriage support rack 26, such that the lifting prong 84 of the fork 14 slides into the passageway 72 in the container 24, as shown in FIG. 9. Once the lifting prong 82 of the fork 14 is completely inserted in the passageway 72, the operator disconnects the fork or forks 14 to be stored from the lift truck, inserts spacer tube 102, as shown in FIG. 2, removes pin 104, shown in FIG. 3, and screws down retaining pin 80 to trap and secure the fork 14 into the device 10. The carriage attachment portion 86 of the fork 14 extends upward from the fork storage container 24 at approximately a 90° angle.

When an operator desires to store the fork lift carriage 12 along with the lift forks 14 attached to the carriage, the operator drives the lift truck up to the device, such that the lifting prongs of the forks 14 are aligned on the base frame 18 atop of the fork storage containers 24. In an embodiment when the plurality of the fork storage containers 24 are spaced apart from one another, the lifting prong 84 of the forks 14 may be aligned with the respective spaces 88 between each of the fork storage containers 24, as shown in FIG. 2. By removing pin 100 (FIG. 7b) the carriage 12 with forks 14 can be detached from the fork lift and stored on the device 10.

Once the lifting prongs 84 of the lift forks 14 are positioned on top of the fork storage container 24, the fork lift carriage 12 is attached to the carriage support rack 26. This may be done in an embodiment, by inserting a pair of carriage support arms 56 on the carriage support rack 26, through a respective pair of mounting rings 58 on the fork lift carriage 12, as shown in FIGS. 7a, 8 and 10.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A device for storing a fork lift carriage and a plurality of lift forks when each are detached from a fork lift truck, the device comprised of:
a base frame having a plurality of sides;
a leg portion extending downward from an end of each of the plurality of sides;
a plurality of elongated fork storage containers attached to the base frame; and
a carriage support rack attached to the base frame opposite of the plurality of fork storage containers.

2. The device of claim 1, wherein:
a first end of each of the plurality of fork storage containers extends beyond the base frame; and
a counterbalancing leg portion proximal to the first end of the fork storage containers, extends angularly downward from the sides of the base frame aligned parallel to an elongated axis of said fork storage containers.

3. The device of claim 1, wherein the carriage support rack includes:
a carriage mounting frame extending from the base frame, and
a carriage support extending from the carriage mounting frame.

4. The device of claim 3, wherein the carriage mounting frame is comprised of:
a first component attached at a first end to the base frame;
a second component attached at a first end to the base frame and displaced from the first component; and
a joining component having a first end and a second end,
whereby the first end of the joining component is attached to a second end of the first component, and the second end of the joining component is attached to a second end of the second component.

5. The device of claim 3, wherein the carriage support is comprised of a pair of carriage support arms that extend from the carriage mounting frame.

6. The device of claim 5, wherein the fork lift carriage includes mounting rings, and each mounting ring receives one of the pair of carriage support arms.

7. The device of claim 3, wherein, a carriage-mounting-frame support brace extends from the carriage mounting frame to the base frame.

8. The device of claim 7, wherein:
the carriage-mounting-frame support brace has a first end and a second end opposite the first end;
the first end of the carriage-mounting-frame support brace is connected to the carriage mounting frame; and
the second end of the carriage-mounting-frame support brace is attached to the base frame,
whereby the carriage-mounting-frame support brace forms approximately a 45° angle with both the carriage mounting frame and the base frame.

9. The device of claim 8, wherein:
a support bracket has a first end and a second end;
the first end of the support bracket is attached to the carriage mounting frame and extends perpendicular therefrom; and
the second end of the support bracket is attached to the carriage-mounting-frame support brace.

10. The device of claim 3, wherein the carriage support forms approximately a 90° angle with the carriage mounting frame.

11. The device of claim 1, wherein;
each of the plurality of fork storage containers attached to the base frame has a first end and a second end; and
the first end defines an opening;
the second end defines an opening; and
a passageway extends through the fork storage container from the first end to the second end.

12. The device of claim 1, wherein at least one support beam extends across an underside of the plurality of fork storage containers.

13. The device of claim 12, wherein:
a first support beam extends across the underside of the plurality of fork storage containers proximal to a second end of the fork storage containers; and
a second support beam extends across the underside of the plurality of fork storage containers approximately midway between the second end of the fork storage containers and the carriage mounting frame.

14. The device of claim 12, wherein the support beam defines a passageway, therethrough.

15. The device of claim 1, wherein a removable spacer can be inserted beneath forks to be removed.

16. The device of claim 1, wherein a retaining pin extends from a top side of each of the plurality of fork storage containers.

17. The device of claim 16, wherein one of the plurality of forks fits between a pair of retaining pins when the forks and fork lift carriage are stored together on the device.

18. The device of claim 16, wherein the retaining pin is located approximately at a midpoint along the length of each of the plurality of fork storage containers.

19. The device of claim 18, wherein the retaining pin is T-shaped.

20. The device of claim 1, wherein the device is made of a metallic like material.

21. The device of claim 1, wherein one of the plurality of forks fits into one of the plurality of fork containers when the fork is detached from the fork lift truck.
